(19) United States
(12) Patent Application Publication
(10) Pub. No.: US 2023/0213808 A1
(43) Pub. Date: Jul. 6, 2023

(54) OPTICAL SYSTEM HAVING ADJUSTABLE FOCAL LENGTH

(71) Applicant: NATIONAL YANG MING CHIAO TUNG UNIVERSITY, Hsinchu City (TW)

(72) Inventors: Yi-Hsin Lin, Zhubei City (TW); Ting-Wei Huang, Shuishang Township (TW); Yu-Jen Wang, Taipei City (TW)

(21) Appl. No.: 17/745,326

(22) Filed: May 16, 2022

(30) Foreign Application Priority Data
Jan. 3, 2022 (TW) 111100121

(51) Int. Cl. G02F 1/1335; G02B 3/14

(52) U.S. Cl. CPC G02F 1/133526; G02B 3/14; G02F 1/133553; G02F 1/133638

(57) ABSTRACT

An optical system includes a pancake lens assembly and a varifocal lens device. The varifocal lens device is coupled to the pancake lens assembly in a way that an optical axis of the varifocal lens device is in alignment with an optical axis of the pancake lens assembly, thereby permitting the optical system to have an adjustable focal length.

### CROSS-REFERENCE TO RELATED APPLICATION

This application claims priority of Taiwanese Invention Patent Application No. 111100121, filed on Jan. 3, 2022.

### FIELD

The disclosure relates to an optical system, and more particularly to an optical system having an adjustable focal length.

### BACKGROUND

A near-eye display (for example, a head-mounted display) for virtual reality (VR) system, an augmented reality (AR) system, and so on, is used to create a virtual image in the field of view (FOV) for both eyes of a user. However, the near-eye display might cause symptoms such as visual fatigue, eyestrain, and so on, which are collectively referred to as vergence-accommodation conflict (VAC). In this case, the two eyes of the user might not verge and accommodate at the same time for estimating the relative distance of objects.

In addition, to give the user an improved FOV, a distance between the near-eye display and each of the eyes is normally kept at a limited range, for example, from about 15 mm to 25 mm. However, the eyes of a user wearing eyeglasses might not be kept in the aforesaid distance range, which might adversely affect the FOV. In addition, it is cumbersome if the eyeglasses are necessary to be provided between the user and the near-eye display for viewing images.

### SUMMARY

Therefore, an object of the disclosure is to provide an optical system having an adjustable focal length which may eliminate or alleviate at least one of the above-mentioned drawbacks.

According to the disclosure, an optical system includes a pancake lens assembly and a varifocal lens device. The varifocal lens device is coupled to the pancake lens assembly in a way that an optical axis of the varifocal lens device is in alignment with an optical axis of the pancake lens assembly, thereby permitting the optical system to have an adjustable focal length.

### BRIEF DESCRIPTION OF THE DRAWINGS

Other features and advantages of the disclosure will become apparent in the following detailed description of the embodiment(s) with reference to the accompanying drawings, in which:

FIG. 1 is a schematic view illustrating an optical system in accordance with a first embodiment;

FIG. 2 is a possible side view of the optical system shown in FIG. 1, illustrating a light path from a display passing through the optical system;

FIG. 3 is a schematic view illustrating a pancake lens assembly of the optical system in a modified embodiment;

FIG. 4 is a schematic view of a pancake lens assembly in another modified embodiment, in which a first polarization controller is in a state for preventing polarization transformation of light;

FIG. 5 is a view similar to that of FIG. 4 but illustrating the first polarization controller in another state for polarization transformation of light;

FIG. 6 is a schematic view illustrating an optical system in accordance with a second embodiment;

FIG. 7 is a possible side view of the optical system shown in FIG. 6, illustrating a light path from a display passing through the optical system;

FIG. 8 is a schematic view illustrating an optical system in accordance with a third embodiment, in which a second polarization controller is in a state for preventing polarization transformation of light;

FIG. 9 is a possible side view of the optical system shown in FIG. 8, illustrating a light path from a display passing through a polarizer and the optical system;

FIG. 10 is a view similar to that of FIG. 8 but illustrating the second polarization controller in another state for polarization transformation of light;

FIG. 11 is a schematic view illustrating an optical system in accordance with a fourth embodiment, in which a second polarization controller is in a state for preventing polarization transformation of light;

FIG. 12 is a possible side view of the optical system shown in FIG. 11, illustrating a light path from a display passing through the optical system;

FIG. 13 is a view similar to that FIG. 11 but illustrating the second polarization controller in another state for polarization transformation of light;

FIG. 14 is a schematic view illustrating an optical system in accordance with a fifth embodiment, in which a second polarization controller is in a state for preventing polarization transformation of light;

FIG. 15 is a view similar to that of FIG. 14 but illustrating the second polarization controller in another state for polarization transformation of light;

FIG. 16 is a schematic view illustrating an optical system in accordance with a sixth embodiment, in which a tunable waveplate is in a waveplate state preventing polarization transformation of light; and

FIG. 17 is a view similar to that of FIG. 16 but illustrating the tunable waveplate in another waveplate state for polarization transformation of light.

### DETAILED DESCRIPTION

Before the disclosure is described in greater detail, it should be noted that where considered appropriate, reference numerals have been repeated among the figures to indicate corresponding or analogous elements, which may optionally have similar characteristics.

To aid in describing the disclosure, directional terms may be used in the specification and claims to describe portions of the present disclosure (e.g., front, rear, left, right, top, bottom, etc.). These directional definitions are intended to merely assist in describing and claiming the disclosure and are not intended to limit the disclosure in any way.

It should be noted that the drawings, which are for illustrative purposes only, are not drawn to scale, and are not intended to represent the actual sizes or actual relative sizes of the components of the pancake lens assembly.

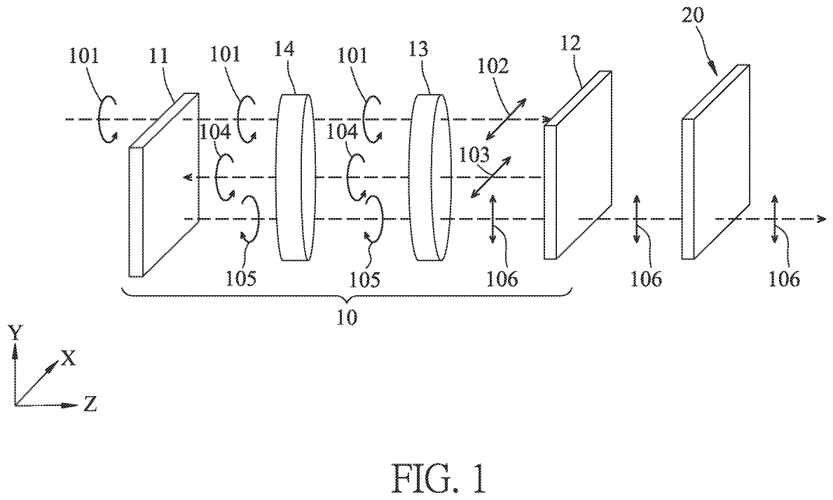

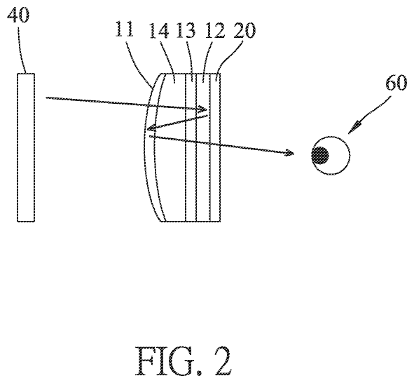

Referring to FIGS. 1 and 2, an optical system in accordance with a first embodiment of the disclosure is shown to include a pancake lens assembly 10 and a varifocal lens device 20. The varifocal lens 20 is coupled to the pancake lens assembly 10 such that an optical axis of the varifocal lens device 20 is in alignment with an optical axis of the pancake lens assembly 10, thereby permitting the optical system to have an adjustable focal length.

In some embodiments, the pancake lens assembly 10 includes a partially reflective mirror 11, a reflective polarizer 12 and a first waveplate 13. The reflective polarizer 12 is disposed rearwardly of the partially reflective mirror 11. The first waveplate 13 is a quarter waveplate, and is disposed between the partially reflective mirror 11 and the reflective polarizer 12.

In some embodiments, the partially reflective mirror 11 may be a beam splitter, for example, a 50/50 mirror which reflects about 50% of a light beam incident thereon and transmits about 50% of the light beam. In some embodiments, the partially reflective mirror 11 is configured to partially transmit a first circularly polarized light, and to partially reflect and transform the first circularly polarized light into a second circularly polarized light having a circular polarization direction different from that of the first circularly polarized light. In addition, the partially reflective mirror 11 is also configured to partially transmit the second circularly polarized light, and to partially reflect and transform the second circularly polarized light into the first circularly polarized light. In some embodiments, as shown in FIG. 1, the first circularly polarized light is a left circularly (L-circularly) polarized light represented by arrows 101, 104, and the second circularly polarized light is a right circularly (R-circularly) polarized light represented by an arrow 105.

In some embodiments, as shown in FIG. 1, the reflective polarizer 12 is configured to reflect a first linearly polarized light, and to transmit a second linearly polarized light having a linear polarization direction different from that of the first linearly polarized light. In some embodiments, the polarization direction of the first linearly polarized light is different from that of the second linearly polarized light by about 90 degrees. In certain embodiments, as shown in FIG. 1, the first linearly polarized light is an X-polarized light represented by arrows 102, 103, and the second linearly polarized light is a Y-polarized light represented by an arrow 106.

In some embodiments, the quarter waveplate 13 is configured to transform the first circularly polarized light into the first linearly polarized light, to transform the first linearly polarized light into the first circularly polarized light, to transform the second circularly polarized light into the second linearly polarized light, and to transform the second linearly polarized light into the second circularly polarized light.

In some embodiments, the pancake lens assembly 10 may further include a lens unit 14 which has an optical power, and which is disposed at one of a forward position between the partially reflective mirror 11 and the first waveplate 13, and a rearward position between the first waveplate 13 and the reflective polarizer 12. In an embodiment shown in FIGS. 1 and 2, the lens unit 14 is located at the forward position. In certain embodiments, as shown in FIG. 1, the lens unit 14 is a polarization-independent lens, and may be a solid lens made of glass or plastic material.

In some embodiments, the pancake lens assembly 10 may be any commercially available pancake lens.

The varifocal lens device 20 is selected from the group consisting of a liquid lens, a liquid crystal lens, and a combination thereof. The varifocal lens device 20 is disposed at one of a first position forwardly of the partially reflective mirror 11, and a second position rearwardly of the reflective polarizer 12. With the varifocal lens device 20, the focal length of the optical system can be adjusted.

In some embodiments, the varifocal lens device 20 is a polarization-dependent optical device. In certain embodiments, as shown in FIG. 1, the varifocal lens device 20 is disposed at the second position.

In some embodiments, as shown in FIG. 2, a light-providing device 40 is disposed to provide a circularly polarized light. In some embodiments, the light-providing device 40 may be a display or other suitable devices. The light-providing device 40 may be an OLED (organic light-emitting diode) display for providing a circularly polarized light. If the light-providing device 40 is an LCD (liquid crystal display) for providing a linearly polarized light, an additional quarter waveplate (not shown) may be used for transforming the linearly polarized light into a circularly polarized light. If the light-providing device 40 is an LED (light-emitting diode) display for providing a non-polarized light, an additional linear polarizer (not shown) and an additional quarter waveplate (not shown) may be used for transforming the non-polarized light into a circularly polarized light. The polarization transformations of the light beam in the optical system are described below with reference to FIGS. 1 and 2. An L-circularly polarized light represented by the arrow 101 from the light-providing device 40 passes through the partially reflective mirror 11 and the lens unit 14 for the first time. Then, the quarter waveplate 13 transforms the L-circularly polarized light into an X-polarized light represented by the arrow 102. The X-polarized light is reflected by the reflective polarizer 12. The quarter waveplate 13 transforms the reflected X-polarized light represented by the arrow 103 into an L-circularly polarized light represented by the arrow 104. Afterward, the L-circularly polarized light passes through the lens unit 14 for the second time. Then, the partially reflective mirror 21 reflects and transforms the L-circularly polarized light into an R-circularly polarized light represented by the arrow 105. Next, the R-circularly polarized light passes through the lens unit 14 for the third time. The quarter waveplate 13 transforms the R-circularly polarized light into a Y-polarized light represented by the arrow 106. The Y-polarized light passes through the reflective polarizer 12 and the varifocal lens device 20 toward an eye 60 of a user.

In some embodiments, as shown in FIG. 2, the elements 11, 14, 13, 12, and 20 may be bonded to each other in the Z direction without gaps therebetween, although they are not so limited.

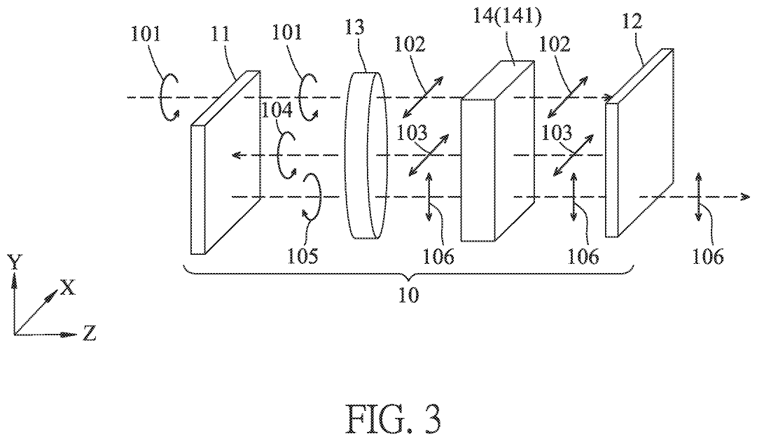

In some embodiments, as shown in FIG. 3, the lens unit 14 is disposed at the rearward position, and includes a polarization-dependent lens 141. The polarization transformations of the light beam in the pancake lens assembly 10 shown in FIG. 3 are similar to those in FIG. 1, except that, in FIG. 3, it is the linearly polarized light that passes through the lens unit 14. In some embodiments, the polarization-dependent lens 141 is selected from the group consisting of a liquid crystal lens with a fixed focus, an electrically tunable focusing liquid crystal lens, a liquid crystal grating, a liquid crystal prism, a liquid crystal wavefront corrector, a metalens, and combinations thereof.

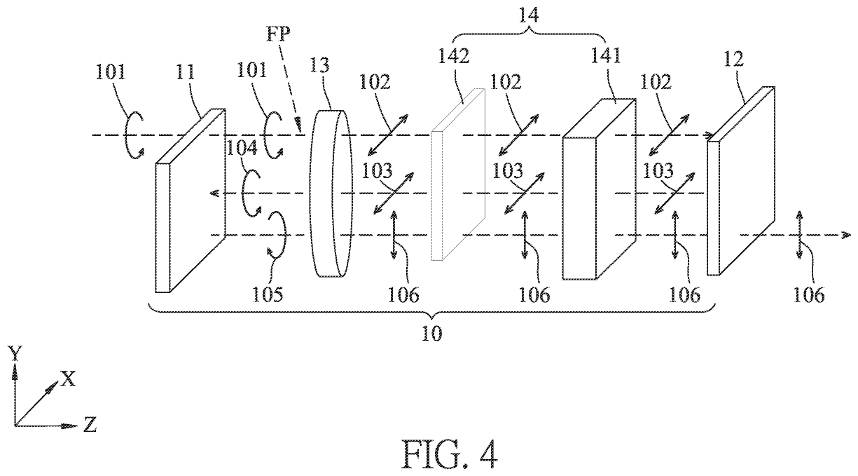

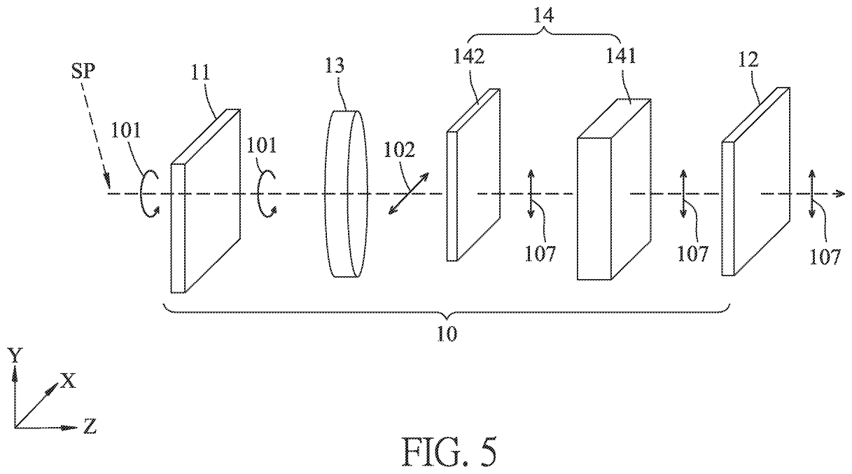

In some embodiments, shown in FIGS. 4 and 5, the lens unit 14 further includes a first polarization controller 142 disposed forwardly of the polarization-dependent lens 141. In alternative embodiments (not shown), the first polarization controller 142 may be disposed rearwardly of the polarization-dependent lens 141. In yet alternative embodiments (not shown), two of the first polarization controllers 142 may be disposed forwardly and rearwardly of the polarization-dependent lens 141, respectively.

In some embodiments, the first polarization controller 142 may be a twisted nematic (TN) liquid crystal cell, a liquid crystal waveplate, and a combination thereof. In certain embodiments, the first polarization controller 142 is a TN liquid crystal cell which can be switched between a first state (off state) and a second state (on state) in a very short time.

As shown in FIG. 4, when the first polarization controller 142 is in the second state, a polarization direction of the light beam is prevented from being converted by the first polarization controller 142. In this the polarization transformations of the light beam in the pancake lens assembly 10 shown in FIG. 4 are substantially the same as those in FIG. 3. That is to say, in the state shown in FIG. 4, a light path in the pancake lens assembly 10 is a folded light path (FP), and the light beam passes through the polarization-dependent lens 141 three times.

As shown in FIG. 5, when the first polarization controller 142 is in the first state, the polarization direction of the light beam is converted by the first polarization controller 142 (i.e., the X-polarized light represented by the arrow 102 is converted by the first polarization controller 142 into a Y-polarized light represented by an arrow 107). Thereafter, the Y-polarized light passes through the polarization-dependent lens 141 and the reflective polarizer 12. That is to say, in the state shown in FIG. 5, a light path in the pancake lens assembly 10 is a straight light path (SP), and the light beam passes through the polarization-dependent lens 141 only one time.

In an embodiment shown in FIGS. 4 and 5, the optical power of the pancake lens assembly 10 can be adjusted by switching the first polarization controller 142.

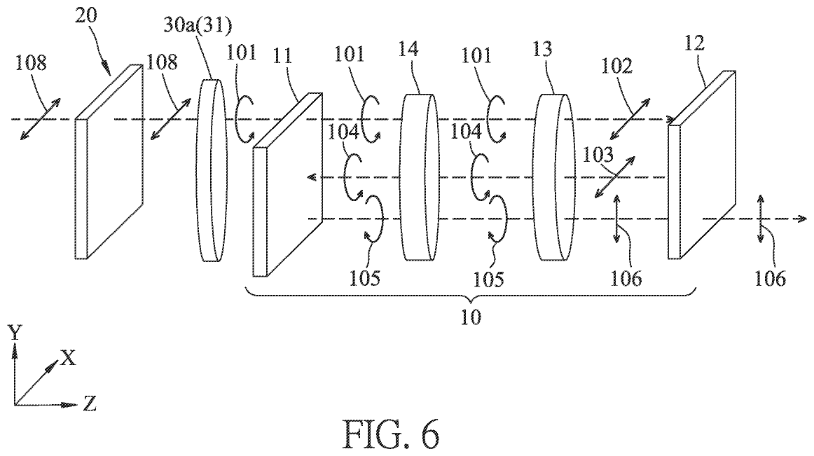

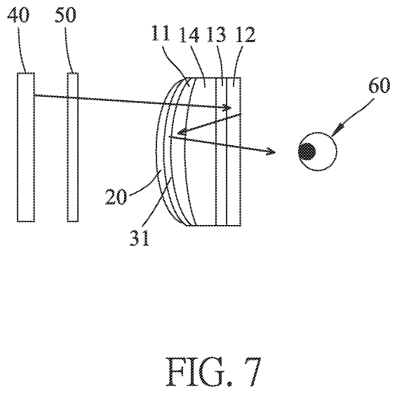

FIGS. 6 and 7 illustrate an optical system in accordance with a second embodiment of the disclosure. The second embodiment is similar to the first embodiment, except that in the second embodiment, the varifocal lens device 20 is disposed at the first position. In addition, the optical system may further include a polarization switchable unit 30a which is coupled to the pancake lens assembly 10 so as to permit polarization transformation of a light beam to pass through at least one of the pancake lens assembly 10 and the varifocal lens device 20.

In an embodiment shown in FIGS. 6 and 7, the polarization switchable unit 30a includes a second waveplate 31 which is disposed between the varifocal lens device 20 and the partially reflective mirror 11 so as to permit polarization transformation of a light beam to pass through the pancake lens assembly 10. The second waveplate 31 may be a quarter waveplate or other suitable waveplates.

In some embodiments shown in FIGS. 6 and 7, a polarizer 50 may be disposed between the varifocal lens device 20 and the light-providing device 40 such that only an X-polarized light represented by an arrow 108 can access the varifocal lens device 20. After the X-polarized light passes through the varifocal lens device 20, the second waveplate 31 transforms the X-polarized light into the L-circularly polarized light represented by the arrow 101. Since the polarization transformations of the light beam in the pancake lens assembly 10 shown in FIG. 6 are substantially the same as those in FIG. 1, details thereof are omitted for sake of brevity. The Y-polarized light represented by the arrow 106 outputted from the pancake lens assembly 10 may access the eye 60 of the user (see FIG. 7).

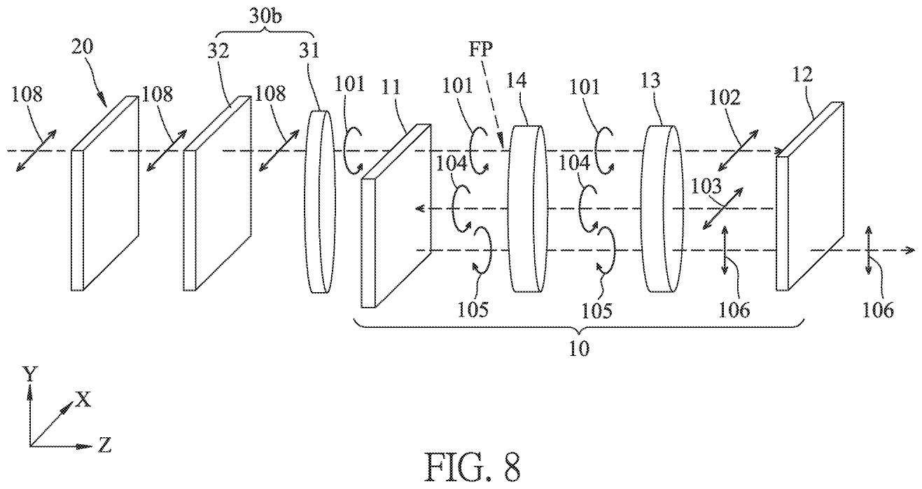

FIGS. 8 to 10 illustrate an optical system in accordance with a third embodiment of the disclosure. The third embodiment is similar to the second embodiment, except that in the third embodiment, a polarization switchable unit 30b includes the second waveplate 31 and a second polarization controller 32 which is disposed at one of a rear position between the varifocal lens device 20 and the second waveplate 31 and a front position forwardly of the varifocal lens device 20. In some embodiments, as shown in FIGS. 8 to 10, the second polarization controller 32 is disposed at the rear position. The second polarization controller 32 is selected from the group consisting of a twisted nematic (TN) liquid crystal cell, a liquid crystal waveplate, and a combination thereof, and is electrically driven to switch from a first state to a second state.

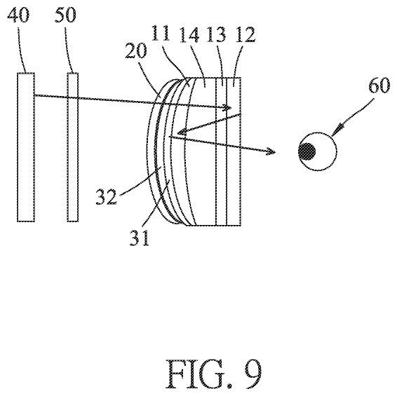

As shown in FIG. 8, when the light beam is introduced into the optical system through the varifocal lens device 20 to pass through the second polarization controller 32 in the second state, the polarization direction of the light beam is prevented from being converted by the second polarization controller 32. When the light beam outputted from the second polarization controller 32 in the second state is introduced into the pancake lens assembly 10 through the second. waveplate 31, a folded light path (FP) is formed between the partially reflective mirror 11 and the reflective polarizer 12. Since the polarization transformations of the light beam in the pancake lens assembly 10 shown in FIG. 8 are substantially the same as those in FIG. 6, details thereof are omitted for the sake of brevity. The Y-polarized light represented by the arrow 106 outputted from the pancake lens assembly 10 may access the eye 60 of the user (see FIG. 9).

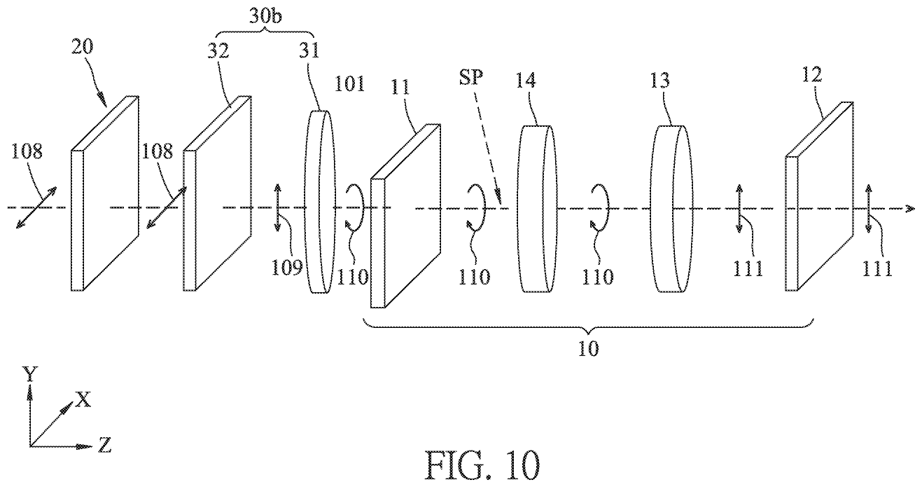

As shown in FIG. 10, when the light beam is introduced into the optical system through the varifocal lens device 20 to pass through the second polarization controller 32 in the first state, a polarization direction of the light beam is converted by the second polarization controller 32. When the light beam outputted from the second polarization controller 32 in the first state is introduced into the pancake lens assembly 10 through the second waveplate 31, a straight light path (SP) is formed to pass through the pancake lens assembly 10. The straight light path (SP) is described below with reference to FIG. 10. The X-polarized light represented by an arrow 108 from the light-providing device 40 (see FIG. 9) passes through the varifocal lens device 20. Then, the second polarization controller 32 the first state transforms the X-polarized light into a Y-polarized light represented by an arrow 109. The second waveplate 31 transform the Y-polarized light into an R-circularly polarized light represented by an arrow 110. Thereafter, the R-circularly polarized light passes through the partially reflective mirror 11 and the lens unit 14. The first waveplate 13 transforms the R-circularly polarized light into a Y-polarized light represented by an arrow 111. Finally, the Y-polarized light passes through the reflective polarizer 12 to access the eye 60 of the user (see FIG. 9).

In an embodiment shown in FIGS. 8 to 10, the light path in the pancake lens assembly 10 can be adjusted by switching the second polarization controller 32, thereby adjusting the optical power of the pancake lens assembly 10.

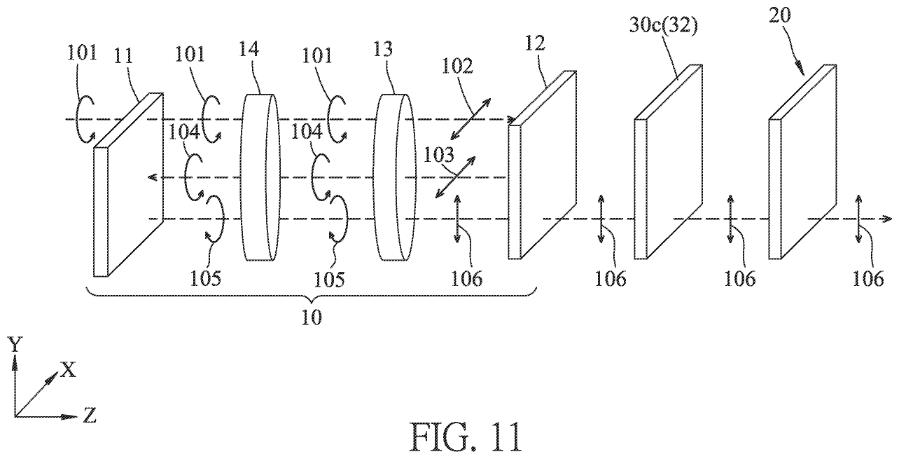

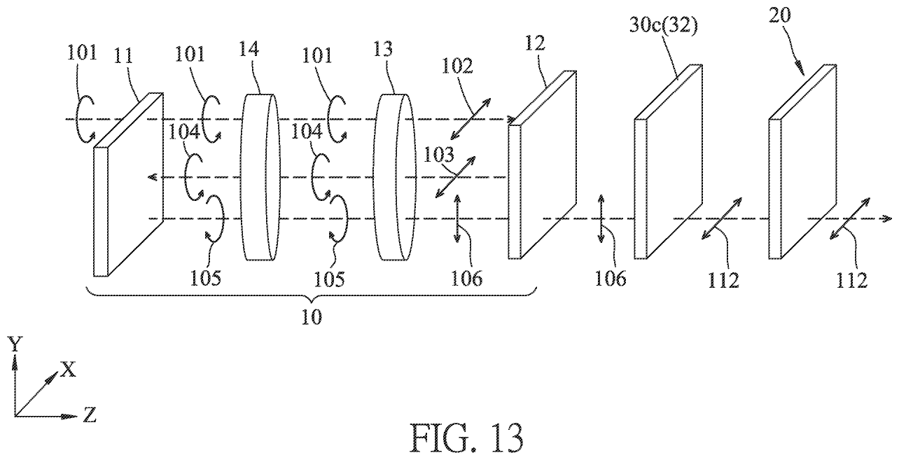

FIGS. 11 to 13 illustrate an optical system in accordance with a fourth embodiment of the disclosure. The fourth embodiment is similar to the first embodiment, except that in the fourth embodiment, the optical system further include a polarization switchable unit 30c which is coupled to the pancake lens assembly 10 so as to permit polarization transformation of a light beam to pass through the varifocal lens device 20. In the fourth embodiment, the polarization transformations of the light beam in pancake lens assembly 10 shown in FIGS. 11 and 13 are substantially the same as those in FIG. 1, and thus details thereof are omitted for the sake of brevity.

In some embodiments, as shown in FIGS. 11 to 13, the polarization switchable unit 30c is the second polarization controller 32 which is disposed between the varifocal lens device 20 and the reflective polarizer 12, and which is electrically driven to switch from the first state to the second state.

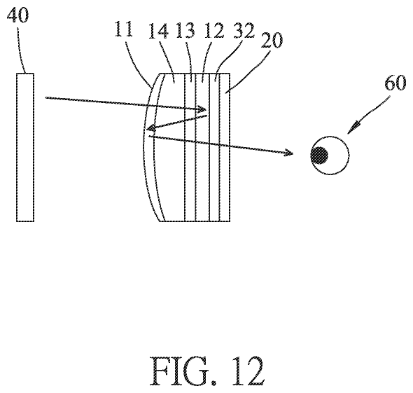

As shown in FIGS. 11 and 12, when the light beam from the light-providing device 40 is introduced into the optical system through the partially reflective mirror 11 to pass through the second polarization controller 32 in the second state, the polarization direction of the light beam is prevented from being converted by the second polarization controller 32. That is to say, the Y-polarized light represented by the arrow 106, outputted from the reflective polarizer 12, can pass through the second polarization controller 32 and the varifocal lens device 20 to access the eye 60 of the user (see FIG. 12).

As shown in FIGS. 12 and 13, when the light beam is introduced into the optical system through the partially reflective mirror 11 to pass through the second polarization controller 32 in the first state, a polarization direction of the light beam is converted by the second polarization controller 32. That is to say, the Y-polarized light represented by the arrow 106, outputted from the reflective polarizer 12, is converted by the second polarization controller 32 into an X-polarized light represented by an arrow 112. Then, the X-polarized light passes through the varifocal lens device 20 to access the eye 60 of the user (see FIG. 12).

It can be noted that, in the embodiments shown in FIGS. 11 to 13, when the varifocal lens device 20 is the polarization-dependent optical device, the optical power of the optical system can be further adjusted by switching the second polarization controller 32.

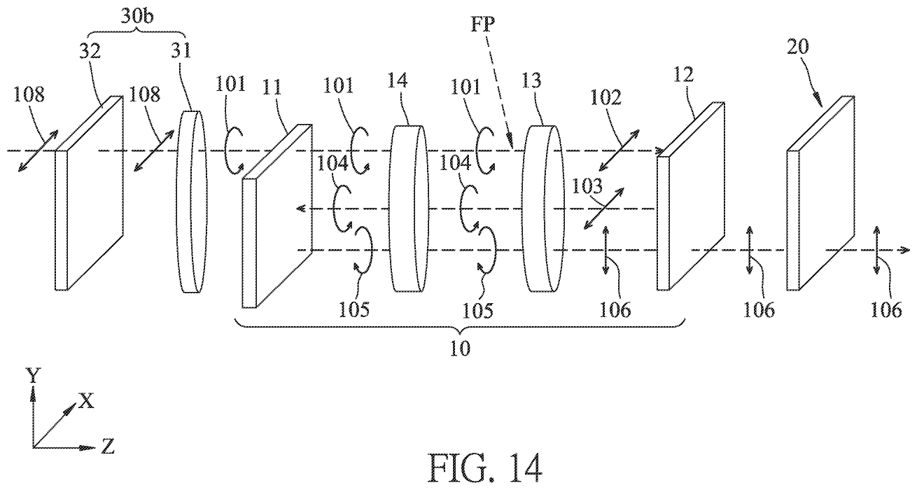

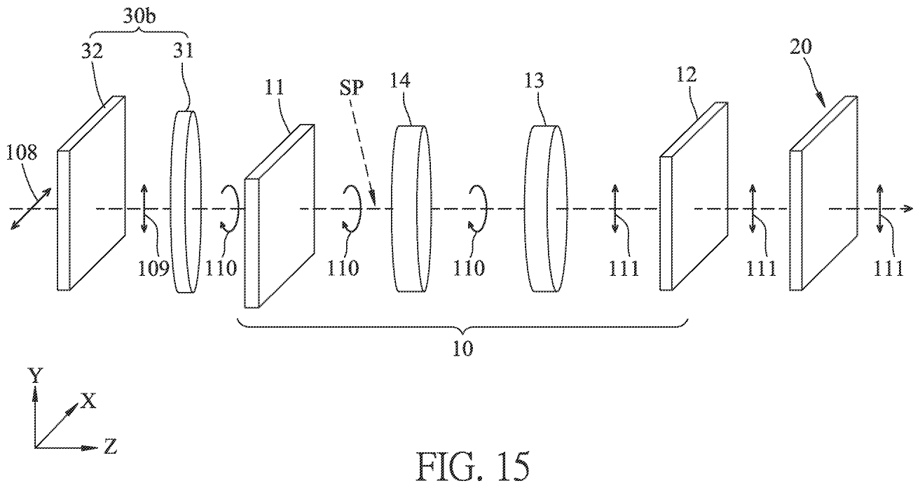

FIGS. 14 and 15 illustrate an optical system in accordance with a fifth embodiment of the disclosure. The fifth embodiment is similar to the third embodiment, except that in the fifth embodiment, the varifocal lens device 20 is disposed at the second position.

As shown in FIG. 14, when the light beam is introduced into the optical system through the second polarization controller 32 in the second state, the polarization direction of the light beam is prevented from being converted by the second polarization controller 32. In this case, (i) a folded light path (FP) is formed in the pancake lens assembly 10, (ii) the polarization transformations of the light beam in the pancake lens assembly 10 shown in FIG. 14 are similar to those in FIG. 8, and (iii) the Y-polarized light represented by the arrow 106 passes through the varifocal lens device 20 to access the eye of the user.

As shown in FIG. 15, when the light beam is introduced into the optical system through the second polarization controller 32 in the first state, a polarization direction of the light beam is converted by the second polarization controller 32. In this case, (i) a straight light path (SP) is formed in the pancake lens assembly 10, (ii) the polarization transformations of the light beam in the pancake lens assembly 10 shown in FIG. 15 are similar to those in FIG. 10, and (iii) the Y-polarized light represented by the arrow 111 passes through the varifocal lens device 20 to access the eye of the user.

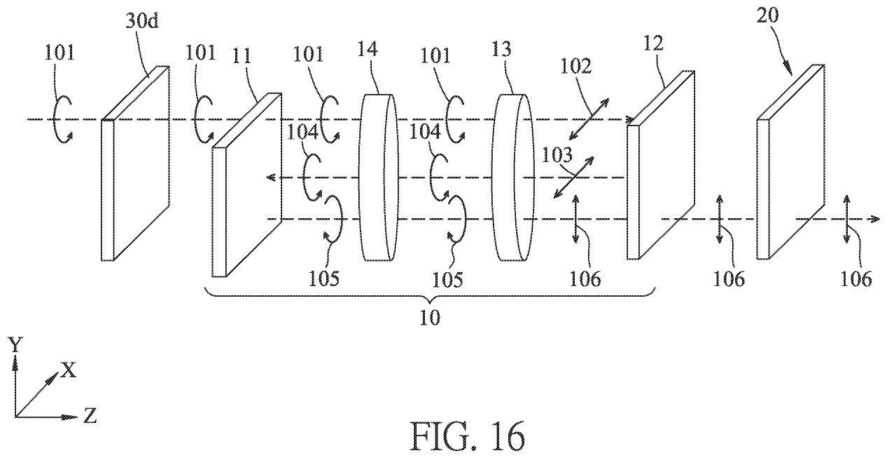

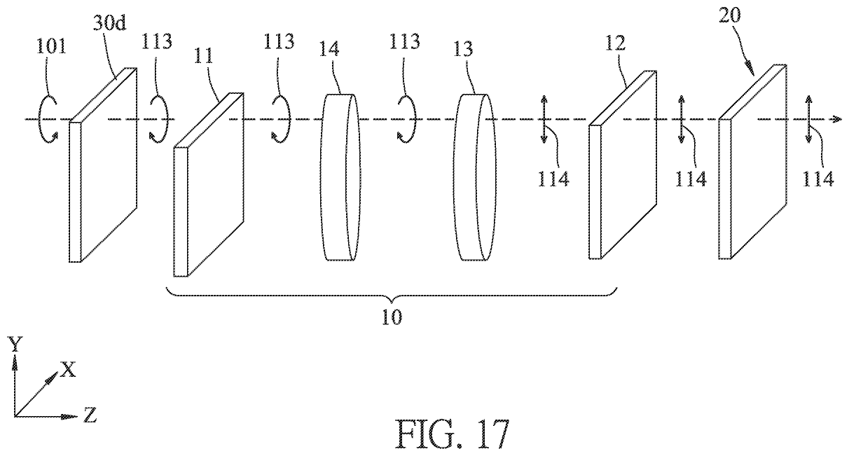

FIGS. 16 and 17 illustrate an optical system in accordance with a sixth embodiment of the disclosure. The sixth embodiment is similar to the first embodiment, except that in the sixth embodiment, the optical system further includes a polarization switchable unit 30d which is coupled to the pancake lens assembly 10 so as to permit polarization transformation of a light beam to pass through the pancake lens assembly 10 and the varifocal lens device 20. In some embodiments, the polarization switchable unit 30d can be switched to transform the first circularly polarized light into the second circularly polarized light, and to transform the second circularly polarized light into the first circularly polarized light.

In some embodiments, as shown in FIGS. 16 and 17, the polarization switchable unit 30d is disposed forwardly of the partially reflective mirror 11, and is a tunable waveplate which is electrically driven to switch between a first waveplate state and a second waveplate state.

As shown in FIG. 16, when the light beam is introduced into the optical system through the tunable waveplate 30d in the second waveplate state, the polarization direction of the light beam is prevented from being converted by the tunable waveplate 30d. Since the polarization transformations of the light beam in the pancake lens assembly 10 shown in FIG. 16 are substantially the same as those in FIG. 1, details thereof are omitted for sake of brevity. Thereafter, the Y-polarized light represented by the arrow 106 passes through the varifocal lens device 20 to access the eye of the user.

As shown in FIG. 17, when the light beam is introduced into the optical system through the tunable waveplate 30d in the first waveplate state, a polarization direction of the light beam is converted by the tunable waveplate 30d. In this case, the tunable waveplate 30d transforms an L-circularly polarized light represented by the arrow 101 from the light-providing device 40 (see FIG. 2) into an R-polarized light represented by an arrow 113. Then, the R-polarized light passes through the partially reflective mirror 11 and the lens unit 14. The quarter waveplate 13 transforms the R-circularly polarized light into a Y-polarized light represented by an arrow 114. Finally, the Y-polarized light passes through the reflective polarizer 12 and the varifocal lens device 20 toward the eye of the user.

In the optical system of the disclosure, a focal length (i.e., an optical power) of the optical system can be adjusted by the varifocal lens device 20. In some embodiments, other elements, such as the first polarization controller 142, the polarization switchable units 30a, 30b, 30c, 10d and so on may be used for further adjusting the optical power of the optical system. Therefore, the optical system of the disclosure may be useful for mitigating the vergence-accommodation conflict (VAC) caused by a near-eye display, and/or for vision correction in the near-eye display.

In addition, the optical system of the disclosure may also serve as at least a portion of a corrective lens for daily vision correction.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An optical system comprising:
a pancake lens assembly; and
a varifocal lens device coupled to said pancake lens assembly in a way that an optical axis of said varifocal lens device is in alignment with an optical axis of said pancake lens assembly, thereby permitting said optical system to have an adjustable focal length.

2. The optical system according to claim 1, wherein
said pancake lens assembly includes
a partially reflective mirror,
a reflective polarizer disposed rearwardly of said partially reflective mirror, and
a first waveplate, which is a quarter waveplate, disposed between said partially reflective mirror and said reflective polarizer.

3. The optical system according to claim 2, wherein said pancake lens assembly further includes a lens unit which has an optical power, and which is disposed at one of a forward position between said partially reflective mirror and said first waveplate, and a rearward position between said first waveplate and said reflective polarizer.

4. The optical system according to claim 3, wherein said lens unit is a polarization-independent lens.

5. The optical system according to claim 3, wherein said lens unit is disposed at the rearward position, and includes a polarization-dependent lens.

6. The optical system according to claim 5, wherein said lens unit further includes at least one first polarization controller disposed forwardly or rearwardly of said polarization-dependent lens.

7. The optical system according to claim 1, wherein said varifocal lens device is selected from the group consisting of a liquid lens, a liquid crystal lens, and a combination thereof.

8. The optical system according to claim 2, wherein said varifocal lens device is a polarization-dependent optical device and is disposed at one of a first position forwardly of said partially reflective mirror, and a second position rearwardly of said reflective polarizer.

9. The optical system according to claim 8, wherein said varifocal leas device is disposed at the second position.

10. The optical system according to claim 8, further comprising a polarization switchable unit which is coupled to said pancake lens assembly so as to permit polarization transformation of a light beam to pass through at least one of said pancake lens assembly and said varifocal lens device.

11. The optical system according to claim 10, wherein said varifocal lens device is disposed at the first position, and said polarization switchable unit includes a second waveplate which is disposed between said varifocal lens device and said partially reflective mirror.

12. The optical system according to claim 11, wherein said polarization switchable unit further includes a second polarization controller which is disposed at one of a rear position between said varifocal lens device and said second waveplate and a front position forwardly of said varifocal lens device, and which is electrically driven to switch from a first state to a second state,
such that when the light beam is introduced into said optical system to pass through said second polarization controller in the first state, a polarization direction of the light beam is converted by said second polarization controller, and
such that when the light beam is introduced into said optical system to pass through said second polarization controller in the second state, the polarization direction of the light beam is prevented from being converted by said second polarization controller.

13. The optical system according to claim 12, wherein said second polarization controller is selected from the group consisting of a twisted nematic liquid crystal cell, a liquid crystal waveplate, and a combination thereof.

14. The optical system according to claim 12, wherein, when the light beam outputted from said second polarization controller in the first state is introduced into said pancake lens assembly through said second waveplate, a straight light path is formed to pass through said pancake lens assembly.

15. The optical system according to claim 12, wherein, when the light beam outputted from said second polarization controller in the second state introduced into said pancake lens assembly through said second waveplate, a folded light path is formed between said partially reflective mirror and said reflective polarizer.

16. The optical system according to claim 10, wherein said varifocal lens device is disposed at the second position, and said polarization switchable unit is a second polarization controller which is disposed between said varifocal lens device and said reflective polarizer, and which is electrically driven to switch from a first state to a second state,
such that when the light beam, is introduced into said optical system through said partially reflective mirror to pass through said second polarization controller in the first state, a polarization direction of the light beam is converted by said second polarization controller, and
such that when the light beam is introduced into said optical system through said partially reflective mirror to pass through said second polarization controller the second state, the polarization direction of the light beam is prevented from being converted by said second polarization controller.

17. The optical system according to claim 10, wherein said varifocal lens device is disposed at the second position, and said polarization switchable unit is disposed forwardly of said partially reflective mirror and includes
a second waveplate, and
a second polarization controller which is disposed forwardly of said second waveplate, and which is electrically driven to switch from a first state to a second state,
such that when the light beam is introduced into said optical system through said second polarization controller in the first state, a polarization direction or the light beam is converted by said second polarization controller, and
such that when the light beam is introduced into said optical system through said second polarization controller in the second state, the polarization direction of the light beam is prevented from being converted by said second polarization controller.

18. The optical system according to claim 10, wherein said varifocal lens device is disposed at the second position, and said polarization switchable unit is disposed forwardly of said partially reflective mirror and is a tunable waveplate which is electrically driven to switch between a first waveplate state and a second waveplate state,
such that when the light beam is introduced into said optical system through said tunable waveplate in the first waveplate state, a polarization direction of the light beam is converted by said tunable waveplate, and
such that when the light beam is introduced into said optical system through said tunable waveplate in the second waveplate state, the polarization direction of the light beam is prevented from being converted by said tunable waveplate.
